(19) United States
(12) Patent Application Publication
(10) Pub. No.: US 2026/0219503 A1
(43) Pub. Date: Jul. 30, 2026

(54) DISPLAY WITH PRE-INCOUPLING DIFFRACTIVE ELEMENT

(71) Applicant: GOOGLE LLC, Mountain View, CA (US)

(72) Inventor: Thomas Hoekman, Redwood City, CA (US)

(21) Appl. No.: 19/146,296

(22) PCT Filed: Jan. 11, 2023
(86) PCT No.: PCT/US2023/010568

§ 371 Date: Jul. 8, 2025

(51) Int. Cl. G02B 27/01; G02B 5/18

(52) U.S. Cl. CPC G02B 27/0172; G02B 5/1842; G02B 5/1871; G02B 2027/0125

(57) ABSTRACT

The present disclosure provides a diffractive element between a light engine and a waveguide and a corresponding incoupler architecture for eyewear displays. The eyewear display includes a light engine to project light associated with displaying an image; a waveguide including a plurality of incouplers; and a diffractive element between the light engine and the waveguide to receive the light projected by the light engine, split the light into a plurality of diffraction orders of light, and direct one diffraction order of light of the plurality of diffraction orders of light to one incoupler of the plurality of incouplers.

### BACKGROUND

In the field of optics, an optical combiner is an optical apparatus that combines light from multiple sources such as environmental light from outside of the optical combiner and light emitted from an image source such as a micro-display (also referred to as projector or light engine) that is directed to the optical combiner via a waveguide. Optical combiners are used in eyewear displays (also referred to as wearable heads up displays (WHUDs), head-mounted displays (HMDs), or near-eye displays) and allow a user to view computer-generated content (e.g., text, images, or video content) superimposed over the user's environment viewed through the eyewear display, creating what is known as augmented reality (AR) or mixed reality (MR).

In an eyewear display, light beams from the light engine are coupled into the waveguide by an input optical coupling (referred to as an “incoupler”) which can be formed on a surface, or multiple surfaces, of the waveguide or disposed within the waveguide. Once the light beams have been coupled into the waveguide, the light beams are “guided” through the waveguide, typically by multiple instances of total internal reflection (TIR), to then be directed out of the waveguide by an output optical coupling (referred to as an “outcoupler”). Additionally, an exit pupil expander between the incoupler and the outcoupler serves to expand the incoupled light in at least one direction prior to it being outcoupled of the waveguide. The outcoupled light beams overlap at an eye relief distance from the waveguide forming an exit pupil within which a virtual image generated by the image source can be viewed by the user of the eyewear display.

### SUMMARY

In a first embodiment, an eyewear display includes a light engine to project light associated with displaying an image and a waveguide including a plurality of incouplers. The eyewear display further includes a diffractive element between the light engine and the waveguide to receive the light projected by the light engine, split the light into a plurality of diffraction orders of light, and direct one diffraction order of light of the plurality of diffraction orders of light to one incoupler of the plurality of incouplers.

In some aspects of the first embodiment, the diffractive element is a diffractive grating. For example, in some embodiments, the diffractive grating is a binary phase diffractive grating to generate the plurality of diffraction orders of light with an equal intensity.

In some aspects of the first embodiment, the diffractive element is configured to split the light into the plurality of diffraction orders of light so that each diffraction order of light of the plurality of diffraction orders of light replicates an input pupil at one incoupler of the plurality of incouplers. In some aspects of the first embodiment, each diffraction order of light of the plurality of diffraction orders of light exits the diffractive element at a different angle with respect to other ones of the plurality of diffraction orders of light. For example, in some embodiments, each of the plurality of incouplers includes grating features to incouple a corresponding diffraction order of light of the plurality of diffraction orders of light. In some cases, the grating features include one or more of a grating height, pitch, fill factor, grating angle, or refractive index of grating material. In some embodiments, each incoupler of the plurality of incouplers incouples the corresponding diffraction order of light into the waveguide along a common incoupling angle. In some embodiments, each incoupler of the plurality of incouplers incouples the corresponding diffraction order of light into the waveguide at a common diffraction efficiency with respect to diffraction orders of light incoupled at other ones of the plurality of incouplers.

In some aspects of the first embodiment, the eyewear display includes a hinge, and the diffractive element is located in the hinge. In other aspects, the diffractive element is between the hinge and the light engine, which is located in an arm of the eyewear display.

In some aspects of the first embodiment, the plurality of incouplers is on a same major surface of the waveguide. In some aspects, the major surface is one of two surfaces that either face the world-side (i.e., away from the user) or the user-side of the eyewear display. In some aspects of the first embodiment, each of the plurality of incouplers are configured to redirect the light toward a two-dimensional (2D) exit pupil expander-outcoupler (EPE/OC) along a separate optical path. In some aspects of the first embodiment, the plurality of incouplers is arranged symmetrically on the waveguide with respect to the diffractive element. In other aspects, the plurality of incouplers is arranged asymmetrically on the waveguide with respect to the diffractive element,

In a second embodiment, a method to direct light in an eyewear display includes projecting, from a light engine, light associated with displaying an image. The method further includes receiving, at a diffractive element, the light and splitting it into a plurality of diffraction orders of light. The method further includes incoupling, at each of a plurality of incouplers on a waveguide, a corresponding diffraction order of light of the plurality of diffraction orders of light such that it is propagated along with waveguide by total internal reflection (TIR).

In some aspects of the second embodiment, splitting the light into the plurality of diffraction orders of light results in each diffraction order of the plurality of diffraction orders of light replicating an input pupil at a corresponding incoupler of the plurality of incouplers. In some aspects of the second embodiment, each of the plurality of diffraction orders of light of light exit the diffractive element at a different angle with respect to one another. In some aspects of the second embodiment, each of the plurality of incouplers incouple a corresponding diffraction order of light into the waveguide along a common incoupling angle or at a common diffraction efficiency with respect to diffraction orders of light incoupled at other ones of the plurality of incouplers. In some aspects of the second embodiment, each of the plurality of incouplers include grating features tuned to account for the different angles of the plurality of diffraction orders of light received from the diffractive element.

In some aspects of the second embodiment, the method includes receiving from the plurality of incouplers at an outcoupler, the plurality of diffraction orders of light along different light paths. In some aspects of the second embodiment, outcoupling, at the outcoupler, the plurality of diffraction orders of light out of the waveguide and to an eyebox of the eyewear display.

In a third embodiment, a device implements a method described above with respect to the second embodiment.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display in accordance with some embodiments.

FIG. 2 shows an example of a projection system with a diffractive element arranged between the light engine and incouplers of a waveguide of an eyewear display, such as that shown in FIG. 1, in accordance with some embodiments.

FIG. 3 shows two examples of different architectures for light propagation within a waveguide, such as that shown in FIG. 2, in accordance with some embodiments.

FIG. 4 shows light propagation from a light engine to a user in an eyewear display, such as that of FIGS. 1 and 2, in accordance with some embodiments.

FIG. 5 shows a side view of a light engine, a diffractive element, and a waveguide with multiple incouplers as well as a corresponding waveguide diagram illustrating the propagation of light within the waveguide in accordance with some embodiments.

FIG. 6 shows another example of a side view of a light engine, a diffractive element, and a waveguide with multiple incouplers as well as a corresponding waveguide diagram illustrating the propagation of light within the waveguide in accordance with some embodiments.

FIG. 7 shows a flowchart illustrating a method for light propagation in an eyewear display in accordance with some embodiments.

### DETAILED DESCRIPTION

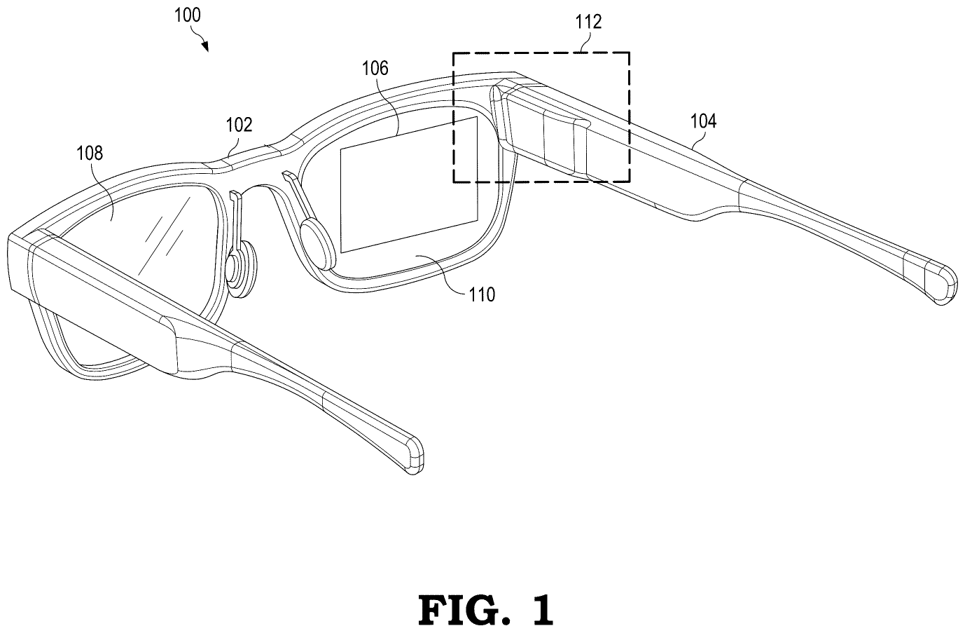

In some cases, the incoupler, exit pupil expander, and the outcoupler may be formed as optical gratings on or within the waveguide of an eyewear display. Each of these optical gratings may be formed with grating features, such as grating height, fill factor, pitch, grating angle or grating material, that are designed to perform associated optical tasks. For example, the incoupler's grating features may be designed to modulate the incoupling efficiency of the light from the light engine, the exit pupil expander's grating features may be designed to maximize the expansion of light in one or more directions, and the outcoupler's grating features may be designed to modulate the outcoupling of light to the user, among other optical tasks. Conventional waveguides in eyewear displays, however, have limited spatial uniformity in the light outcoupled to the user due to constraints in optical grating fabrication processes as well as constraints in the waveguide architecture such as needing to be accommodated within a form factor. For example, in situations where a single incoupler (either per color or for all the colors) is used, the light incoupled into the waveguide inevitably decays as the distance from the incoupler increases. A characteristic spatial illuminance map for an eyebox associated with the single incoupler will be brightest closer to the incoupler and dimmer further away from the incoupler. In many cases, this results in a non-uniform display of light that is outcoupled to the user. Conventional waveguide techniques attempt to address this issue by modulating the grating features of the outcoupler and exit pupil expander to vary the local diffraction efficiency to provide some level of spatial uniformity in the light outcoupled by the waveguide. However, there are fundamental limits in the fabrication of these optical gratings due to their size that restricts the range of their diffraction efficiencies. This intrinsically limits the spatial uniformity of the light that is outcoupled to the user in spatially constrained systems such as eyewear displays. FIGS. 1-7 illustrate techniques to improve the spatial uniformity of the light in and delivered by the waveguide by inserting a diffractive element in between the light engine and the waveguide. This diffractive element increases the expansion of light prior to it being incoupled into the waveguide, thereby reducing the burden of increasing the spatial uniformity of light that would typically fall solely on the exit pupil expander and the outcoupler. This results in an improvement of the spatial uniformity of the light delivered by the eyewear display and an expanded eyebox that is compatible with a larger population of users.

To illustrate, in some embodiments, an eyewear display includes a light engine to project light associated with displaying an image and a waveguide with multiple incouplers to incouple the projected light. A diffractive element, such as a Dammann grating, is located in between the light engine and the waveguide. The diffractive element receives the light projected from the light engine and splits the light into a plurality of diffraction orders of light. Each diffraction order of light is directed to one of the multiple incouplers. In some embodiments, each of the multiple incouplers is designed with grating features (e.g., grating height, fill factor, pitch, grating angle, or grating material of the respective incoupler) to incouple the corresponding diffraction order of light from the diffractive element such that the diffraction efficiency and/or incoupling angle of light associated with each of the multiple incouplers is consistent with the other incouplers. Accordingly, by incoupling the multiple diffraction orders of light at the multiple incouplers and directing them through an exit pupil expander in the waveguide to be outcoupled at an outcoupler of the waveguide, the burden to provide better spatial uniformity within the waveguide itself is reduced. As a result, the spatial uniformity of light outcoupled to the user in space-constrained systems such as eyewear displays is increased.

FIGS. 1-7 illustrate techniques to split light associated with an image into multiple paths, each path incident on one of multiple incouplers that are designed to incouple the diffracted order of light along its corresponding path. This increases the spatial uniformity of the light incoupled into and eventually outcoupled by the waveguide, thereby improving the spatial uniformity of the light delivered to the eyebox of the eyewear display. However, it will be appreciated that the apparatuses and techniques of the present disclosure are not limited to implementation in this particular display system or method, but instead may be implemented in any of a variety of display systems using the guidelines provided herein.

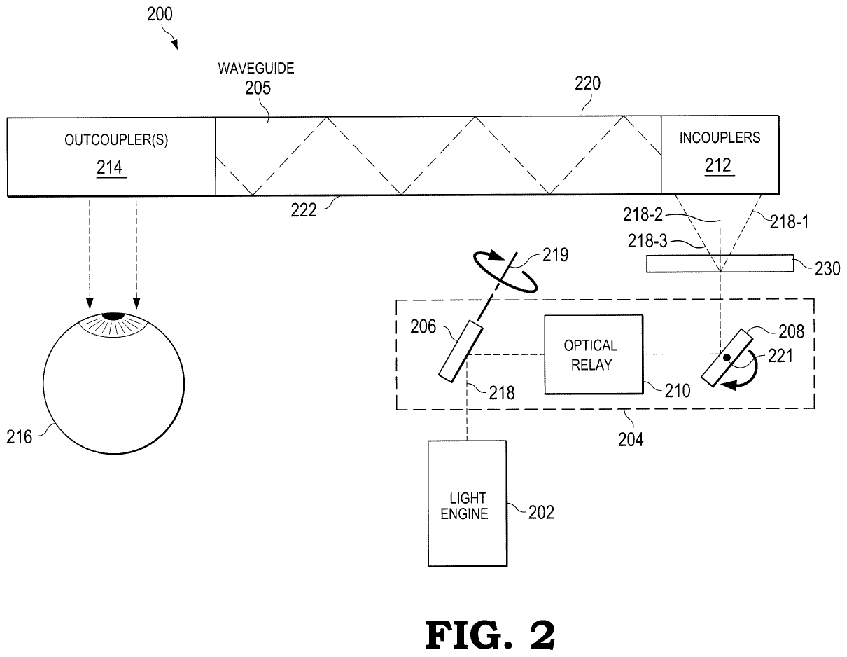

FIG. 1 illustrates an example eyewear display 100 in accordance with various embodiments. The eyewear display 100 has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as a light engine and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

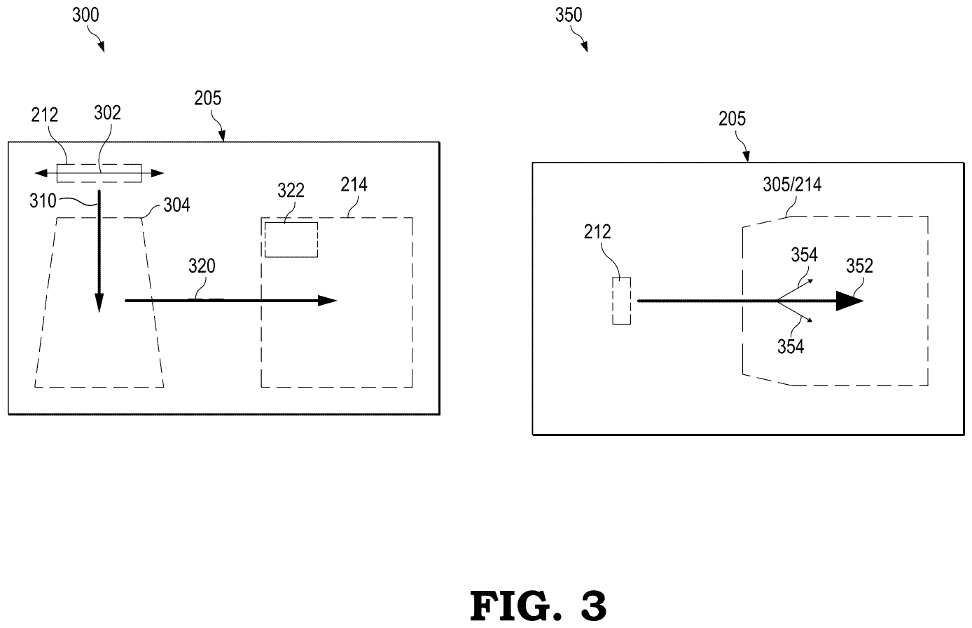

One or both of the lens elements 108, 110 are used by the eyewear display 100 to provide an augmented reality (AR) or mixed reality (MR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from a light engine in the eyewear display 100. For example, light used to form a perceptible image or series of images may be projected by the light engine of the eyewear display 100 onto the eye of the user via a series of optical elements, such as a waveguide formed at least partially in the corresponding lens element, one or more scan mirrors, and one or more optical relays, and/or one or more prisms. In some embodiments, a diffractive element is located between the waveguide and the light engine to increase the pupil expansion function of the light between the light engine and the waveguide to reduce the burden of exit pupil expansion on the elements within the waveguide (e.g., on the exit pupil expander (EPE) shown in FIG. 3). One or both of the lens elements 108, 110 thus includes at least a portion of a waveguide that routes display light received by an incoupler of the waveguide to an outcoupler of the waveguide, which outputs the display light toward an eye of a user of the eyewear display 100. The display light is modulated and projected onto the eye of the user such that the user perceives the display light as an image in FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, the light engine is a digital light processing-based projector, a scanning laser projector, or any combination of a modulative light source such as a laser or one or more light-emitting diodes (LEDs) or organic light-emitting diodes (OLEDs) located in region 112. In some embodiments, the light engine includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The light engine is communicatively coupled to the controller (not shown) and a non-transitory processor-readable storage medium or memory storing processor-executable instructions and other data that, when executed by the controller, cause the controller to control the operation of the light engine. In some embodiments, the controller controls a scan area size and scan area location for the light engine and is communicatively coupled to a light engine (not shown) that generates content to be displayed at the eyewear display 100. The light engine scans light over a variable area, designated the FOV area 106, of the eyewear display 100. The scan area size corresponds to the size of the FOV area 106, and the scan area location corresponds to a region of one of the lens elements 108, 110 at which the FOV area 106 is visible to the user. Generally, it is desirable for a display to have a wide FOV area 106 to accommodate the outcoupling of light across a wide range of angles.

As previously mentioned, a waveguide is integrated into one or both of lens elements 108, 110. In some embodiments, the waveguide includes a single waveguide substrate and in other embodiments, the waveguide includes multiple waveguide substrates stacked on top of one another (referred to as a waveguide stack). In some embodiments, the waveguide is separated from the light engine by a first distance that is restricted by the form factor of the eyewear display 100 and a diffractive element is located within this first distance, i.e., between the waveguide and the light engine. The diffractive element receives the light emitted from the light engine and splits the light into multiple diffraction orders, where each diffraction order is directed to one of the multiple incouplers. In some embodiments, each of the incouplers is specifically tuned to receive light of its corresponding diffraction order from the diffractive element. This increases the exit pupil expansion function prior to entry into the waveguide, thereby reducing the burden on the waveguide to produce a better spatial uniformity in the light provided to the user over the FOV area 106.

FIG. 2 illustrates a diagram of a projection system 200 that projects images directly onto the eye 216 of a user in accordance with various embodiments. The projection system 200, which may be implemented in the eyewear display 100 in FIG. 1, includes one or more of a light engine 202, an optical scanner 204, a diffractive element 230, and/or a waveguide 205. In this example, the optical scanner 204 includes a first scan mirror 206, a second scan mirror 208, and an optical relay 210. The waveguide 205 includes multiple incouplers 212 and one or more outcouplers 214, with the outcoupler(s) 214 being optically aligned with an eye 216 of a user. For example, the outcoupler(s) 214 substantially overlap with the FOV area 106 shown in FIG. 1.

The light engine 202 includes one or more light sources configured to generate and project display light 218 (e.g., visible light such as red, blue, and green light and, in some embodiments, non-visible light such as infrared light). In some embodiments, the light engine 202 is coupled to a driver or other controller (not shown), which controls the timing of emission of display light from the light sources of the light engine 202 in accordance with instructions received by the controller or driver from a computer processor coupled thereto to modulate the display light 218 to be perceived as images when output to the retina of an eye 216 of a user. For example, during operation of the projection system 200, one or more beams of display light 218 are output by the light source(s) of the light engine 202 and then directed into the waveguide 205 before being directed to the eye 216 of the user. The light engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, the light engine 202 projects the display light 218 to an optical scanner 204. One or both of the scan mirrors 206 and 208 of the optical scanner 204 are MEMS mirrors in some embodiments. For example, the scan mirror 206 and the scan mirror 208 are MEMS mirrors that are driven by respective actuation voltages to oscillate during active operation of the projection system 200, causing the scan mirrors 206 and 208 to scan the light 218. Oscillation of the scan mirror 206 causes light 218 output by the optical engine 202 to be scanned through the optical relay 210 and across a surface of the second scan mirror 208. The second scan mirror 208 scans the light 218 received from the scan mirror 206 toward the incouplers 212 of the waveguide 205. In some embodiments, the scan mirror 206 oscillates along a first scanning axis 219, such that the light 218 is scanned in only one dimension (i.e., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the optical relay 210 is a line-scan optical relay that receives the light 218 scanned in a first dimension by the first scan mirror 206 (e.g., the first dimension corresponding to the small dimension of the incouplers 212), routes the light 218 to the second scan mirror 208, and introduces a convergence to the light 218 in the first dimension to an exit pupil beyond the second scan mirror 208. Herein, an “exit pupil” in an optical system refers to the location along the optical path where beams of light intersect. For example, the possible optical paths of the light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the light corresponding to that exit pupil. Accordingly, the exit pupil can be considered a “virtual aperture.” According to various embodiments, the optical relay 210 includes one or more collimation lenses that shape and focus the light 218 on the second scan mirror 208 or includes a molded reflective relay that includes two or more spherical, aspheric, parabolic, and/or freeform lenses that shape and direct the light 218 onto the second scan mirror 208. The second scan mirror 208 receives the light 218 and scans the light 218 in a second dimension, the second dimension corresponding to the long dimension of the incouplers 212 of the waveguide 205. In some embodiments, the second scan mirror 208 causes the exit pupil of the light 218 to be swept along a line along the second dimension.

In some embodiments, the light engine 202 projects light 218 directly to the diffractive element 230. That is, in some embodiments, the optical scanner 204 is absent from projection system 200. Accordingly, in such embodiments, the light engine 202 is arranged such that the optical path of the light 218 emitted from the light engine 202 is in line with the incouplers 212 with the diffractive element 230 arranged therebetween.

In some embodiments, the light directed towards the incouplers 212 of the waveguide 205 from the light engine 202 is transmitted through diffractive element 230. The diffractive element 230 separates the light 218 into multiple diffraction orders of light 218-1 to 218-3. In this example, three diffraction orders of light are shown but it is appreciated that this number may be scalable to other numbers such as 2, 4, 5, or 6. In some embodiments, each of the multiple diffraction orders of light 218-1 to 218-3 are directed by the diffractive element 230 to one of the incouplers 212. In some embodiments where the waveguide 205 includes multiple incouplers 212, the waveguide 205 also includes multiple corresponding exit pupil expanders (shown in FIG. 3) and/or outcouplers 214.

In some embodiments, each of the incouplers 212 has a substantially rectangular profile and each of the incouplers 212 are configured to receive the display light 218 (or a corresponding diffraction order of display light 218-1 to 218-3) and direct the display light 218 into the waveguide 205. The incouplers 212 are defined by a smaller dimension (i.e., width) and a larger orthogonal dimension (i.e., length). In this manner, the waveguide 205 of the projection system 200 includes the incouplers 212 and the outcoupler(s) 214. The term “waveguide,” as used herein, will be understood to mean a combiner using one or more of total internal reflection (TIR), specialized filters, or reflective surfaces, to transfer light from an incoupler (such as incouplers 212) to an outcoupler (such as the outcoupler(s) 214). In some display applications, the light is a collimated image, and the waveguide 205 transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the light 218 received at the incouplers 212 is relayed to the outcoupler(s) 214 via the waveguide 205 using TIR. A portion of the light 218 is then output to the eye 216 of a user via the outcoupler(s) 214. Also, in some embodiments, one or more exit pupil expanders (not shown), such as a fold grating, are arranged in an intermediate stage between incouplers 212 and outcoupler(s) 214 to receive light that is coupled into waveguide 205 by the incouplers 212, expand the light in one dimension, and redirect the light towards the outcoupler(s) 214, where the outcoupler(s) 214 then couples the light out of waveguide 205. In some embodiments, the exit pupil expander and the outcoupler(s) 214 are integrated into a common component (shown in architecture diagram 350 in FIG. 3). As described above, in some embodiments the waveguide 205 is implemented in an optical combiner as part of an eyeglass lens, such as the lens element 108, 110 (FIG. 1) of the display system having an eyeglass form factor and employing projection system 200.

The waveguide 205 further includes two major surfaces 220 and 222, with major surface 220 being world-side (i.e., the surface farthest from the user) and major surface 222 being eye-side (i.e., the surface closest to the user). In some embodiments, the waveguide 205 is between a world-side lens and an eye-side lens, which form lens elements 108, 110 shown in FIG. 1, for example. In some embodiments, the incouplers 212 and the outcoupler(s) 214 are located, at least partially, at major surface 220. In another embodiment, the incouplers 212 and the outcoupler(s) 214 are located, at least partially, at major surface 222. In further embodiments, the incouplers 212 are located at one of the major surfaces, while the outcoupler(s) 214 are located at the other of the major surfaces.

Referring back to the diffractive element 230, the diffractive element 230 splits and directs light projected from the light engine 202 to each of the incouplers 212 so that light is coupled into incouplers 212 at the appropriate angle(s) to encourage propagation of the light in waveguide 205 by TIR. In some embodiments, the diffractive element 230 is a Dammann grating, which is a binary phase diffraction grating that generates linear or two-dimensional (2D) arrays of equal intensity diffraction orders. In some embodiments, the diffractive element 230 is a non-binary phase diffractive grating such as a sinusoidal grating. In some embodiments, diffractive element 230 is a symmetrical grating to produce symmetrical diffraction orders. In other embodiments, the diffractive element 230 is a non-symmetrical grating in which the symmetry along the grating is broken by using blazed or slanted gratings, for example. Depending on the configuration of the projection system 200, the diffractive element 230 may include a non-symmetrical grating to use in tandem with an even number (e.g., 2, 4, or 6) of incouplers 212. In these cases, the diffractive element 230 diffracts the light into non-equal diffraction orders of light. To compensate for the non-equality of the diffraction orders of light, the incoupling efficiency of the corresponding incouplers 212 is modulated by designing the grating features to provide a common incoupling diffraction efficiency and/or angle for the non-equal diffraction orders of light for forwarding to the same exit pupil expander and outcoupler. Other examples of structures that can be used for the diffractive element 230 include Damman blazed or slanted grating, a volume holographic grating, and a metasurface.

In sum, the diffractive element 230 receives the display light 218 from the light engine 202 (in some embodiments, via optical scanner 204) and splits the display light 218 into different diffraction orders of light 218-1 to 218-3. Each one of the diffraction orders of light 218-1 to 218-3 is sent to a corresponding incoupler of the incouplers 212. In this example, the incouplers 212 include three incouplers (not shown), where each incoupler is designed to receive light of a corresponding diffraction order 218-1 to 218-3. Parameters of the incoupler grating that can be tuned include, but are not limited to, grating height, grating spacing, grating angles, grating density, pitch, and the fill factor. Each of the incouplers 212 are therefore tuned to received light of one of diffraction orders of light 218-1 to 218-3 and incouple the light into the waveguide 205 with a same or similar diffraction efficiency and/or angle as the other ones of the incouplers 212. This increases the exit pupil expansion function prior to entry into the waveguide 205, thereby reducing the burden on the waveguide 205 to produce a better spatial uniformity in the outcoupled light from the outcoupler(s) 214 that is provided to the user 216.

FIG. 3 shows two configuration diagrams 300, 350 for light propagation within the waveguide 205 in accordance with various embodiments. Configuration diagram 300 shows a one-dimensional (1D) exit pupil expander (EPE) and outcoupler (OC) (EPE-OC) architecture while configuration diagram 350 shows a two-dimensional (2D) integrated EPE and OC (EPE/OC) architecture.

As shown in configuration diagram 300, in some embodiments, the waveguide 205 includes a 1D EPE-OC architecture. In this architecture, light is received via the incoupler 212, which is scanned along the axis 302, and then directed as light 310 into an EPE 304. The EPE 304 expands the light in one dimension and then routs the expanded light 320 to the OC 214 to be output (e.g., toward the eye of the user). In some embodiments, the OC 214 expands the light in a second dimension. Accordingly, the EPE 304 and the OC 214 expand one or more dimensions of the eyebox of an eyewear display system that includes the projection system 200 (e.g., with respect to what the dimensions of the eyebox of the eyewear display system would be without the EPE 304). In some embodiments, the incoupler 212 and the EPE 304 each include respective one-dimensional diffraction gratings (i.e., diffraction gratings with features that vary along one dimension). It should be understood that FIG. 3 shows a case in which the incoupler 212 directs light straight down 310 (with respect to the presently illustrated view) in a first direction that is perpendicular to the scanning axis 302, and the EPE 304 directs light to the right 320 (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

Generally, for conventional systems employing the 1D EPE-OC architecture shown in 300, the light at the top left corner 322 of the outcoupler 214 is brighter than the light at the other portions of the outcoupler 214. That is, the spatial uniformity of the light provided to and then outcoupled by the outcoupler 214 is relatively low due to pupil expansion limitations imposed by the physical grating constraints in the EPE 304 and the OC 214. The techniques of the present disclosure increase the spatial uniformity of the light by including a diffractive element that separates the display light into different diffraction orders to be incoupled at multiple incouplers (shown in FIGS. 2 and 4-7, for example). This increases the pupil expansion of the light prior to entry into the waveguide 205. Therefore, the pupil expansion burden on the EPE 304 is reduced and the quality of the image delivered to the user is improved due to the increase in spatial uniformity.

As shown in configuration diagram 350, in some embodiments, the waveguide 205 includes a 2D EPE/OC architecture. That is, the EPE 305 and the OC 214 are integrated into a single component represented by 305/214 which expands the light in two dimensions as shown by arrows 352, 354. However, in conventional systems employing a 2D EPE/OC architecture, the light at the center part of the EPE/OC 305/214 (along arrow 352) is brighter than the light at the top or bottom of EPE/OC 305/214. That is, the spatial uniformity of the light provided to and then outcoupled by the EPE/OC 305/214 is relatively low due to pupil expansion limitations imposed by the physical constraints of the grating features of the EPE/OC 305/214. The techniques of the present disclosure increase the spatial uniformity of the light by including a diffractive element that separates the display light into different diffraction orders to be incoupled at multiple incouplers (shown in FIGS. 2 and 4-7, for example). This increases the pupil expansion of the light prior to entry into the waveguide 205. Therefore, the pupil expansion burden on the EPE/OC 305/214 is reduced and the quality of the image delivered to the user is increased.

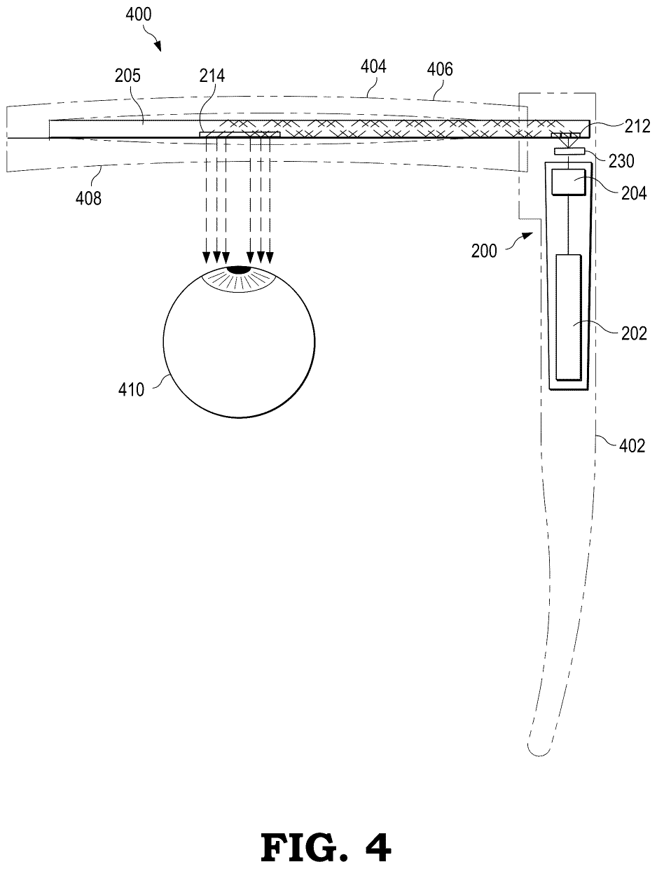

FIG. 4 illustrates a portion of an eyewear display 400 that includes the projection system 200 of FIG. 2 in accordance with various embodiments. In some embodiments, the eyewear display 400 represents the display 100 of FIG. 1 and includes the components of the projection system 200 of FIG. 2. The light engine 202, the optical scanner 204, the incoupler 212, the diffractive element 230, and a portion of the waveguide 205 are included in an arm 402 of the eyewear display 400, in the present example.

The eyewear display 400 includes an optical combiner lens 404, which includes a first lens 406, a second lens 408, and the waveguide 205, with the waveguide 205 disposed between the first lens 406 and the second lens 408. Light exiting through the outcoupler 214 travels through the second lens 408 (which corresponds to, for example, the lens element 110 of the eyewear display 100). In use, the light exiting second lens 408 enters the pupil of an eye 410 of a user wearing the eyewear display 400, causing the user to perceive a displayed image carried by the laser light output by the light engine 202. The optical combiner lens 404 is substantially transparent, such that light from real-world scenes corresponding to the environment around the eyewear display 400 passes through the first lens 406, the second lens 408, and the waveguide 205 to the eye 410 of the user. In this way, images or other graphical content output by the projection system 200 are combined (e.g., overlayed) with real-world images of the user's environment when projected onto the eye 410 of the user to provide an AR experience to the user. The eyebox of eyewear display 400 corresponds to the region (or volume) in which the eye 410 of the user can perceive images associated with light projected from light engine 202.

In some embodiments additional optical elements are included in any of the optical paths between the light engine 202 and the incouplers 212, in between the incouplers 212 and the outcoupler(s) 214, and/or in between the outcoupler(s) 214 and the eye 410 of the user (e.g., in order to shape the display light from light engine 202 for viewing by the eye 410 of the user). As an example, the diffractive element 230 is used to split the display light from the light engine 202 into a plurality of diffraction orders of light to be incoupled into the waveguide 205 by a corresponding one of a plurality of incouplers 212. In some embodiments, the diffractive element 230 is located in the hinge of the eyewear display 400, and in other embodiments, it is located before the hinge of the eyewear display 400 (as shown in FIG. 4). In the example shown in FIG. 4, the eyewear display 400 includes three incouplers 212 located on the waveguide 205, although it is appreciated that this number is exemplary in nature and may be scalable to other quantities (e.g., 2, 4, 5, or 6). In some embodiments, the grating features of each one of the incouplers 212 is designed such that it receives its corresponding diffractive order of light from the diffractive element 230 and incouples it into the waveguide 205 at the appropriate angle to encourage propagation of the light in waveguide 205 by TIR. In this manner, the diffractive element 230 and the incouplers 212 provide a function of pupil expansion prior to the light entering the incouplers 212 in order to increase the spatial uniformity of light that is eventually provided to the eye 410 of the user. Also, in some embodiments, an exit pupil expander (e.g., the exit pupil expander 304), such as a fold grating, is arranged in an intermediate stage between incouplers 212 and outcoupler(s) 214 to receive light that is coupled into waveguide 205 by the incouplers 212, further expand the light, and redirect the light towards the outcoupler(s) 214, where the outcoupler(s) 214 then couples the light out of waveguide 205 (e.g., toward the eye 410 of the user).

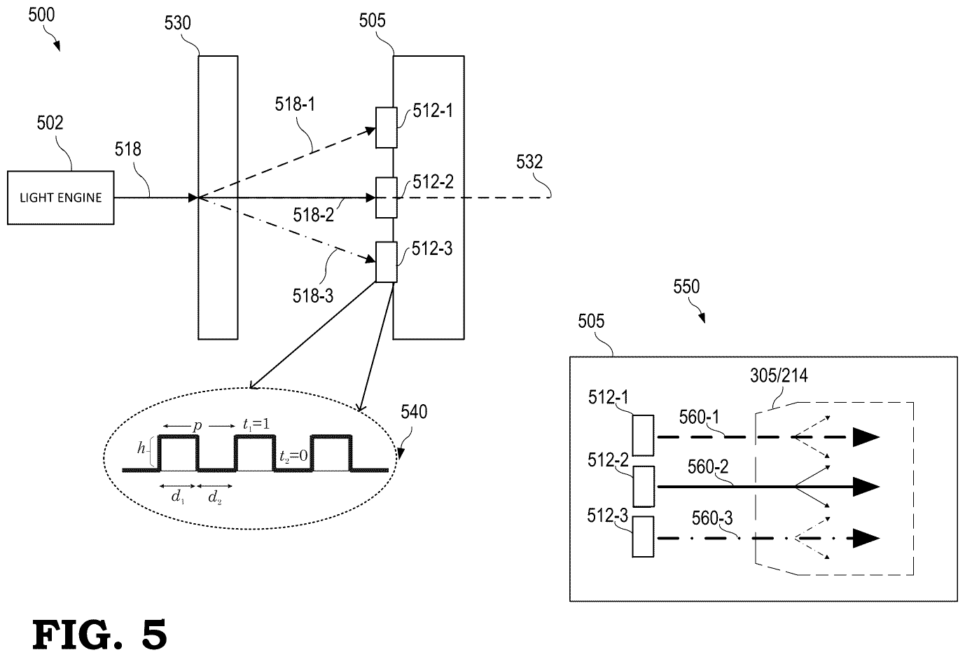

FIG. 5 illustrates a side view of a projection system diagram 500 and a corresponding waveguide diagram 550 in accordance with various embodiments. It is appreciated that diagrams 500 and 550 are simplified to emphasize the components of the ensuing explanation and may therefore include other components, such as those discussed in FIGS. 1-4, that are not shown. Light engine 502 may correspond to light engine 202 in FIGS. 2 and 4, diffractive element 530 may correspond to diffractive element 230 of FIGS. 2 and 4, waveguide 505 (or waveguide portion) may correspond to waveguide 205 of FIGS. 2-4, and incouplers 512-1 to 512-3 may correspond to incouplers 212 of FIGS. 2-4.

In projection system diagram 500, the light engine 502 projects light 518 associated with displaying an image. The diffractive element 530 receives the light 518 and splits the light into three diffraction orders of light 518-1 to 518-3. Each of the three diffraction orders of light 518-1 to 518-3 are directed to one of three corresponding incouplers 512-1 to 512-3 on the waveguide 505. That is, the quantity and location of the incouplers 512-1 to 512-3 are selected to coincide with the number of diffraction orders of light 518-1 to 518-3 generated by the diffractive element 530. In this example, this number is 3, but it is appreciated that this number may be scalable to other amounts, e.g., 2, 4, 5, or 6.

As shown in projection system diagram 500, the diffractive element 530 is placed between the light engine 502 and the waveguide 505 to allow for the incouplers 512-1 to 512-3 to be spatially separated in order to receive its corresponding diffraction order of light 518-1 to 518-3. Accordingly, the configuration shown in diagram 500 includes considerations for the placement and location of the diffractive element 530 in the optical path between the light engine 502 and the waveguide 505. In some embodiments, the diffractive element 530 is designed with diffractive features to generate the diffractive orders of light 518-1 to 518-3 based on the physical distance and/or optical path length of light between the waveguide 505 and the light engine 502. The diffractive features of the diffractive element 520 that may be designed (also referred to as tuned or modulated) include, for example, grating height, pitch, fill factor, grating angle, grating density, the refractive index of the material used, or the like.

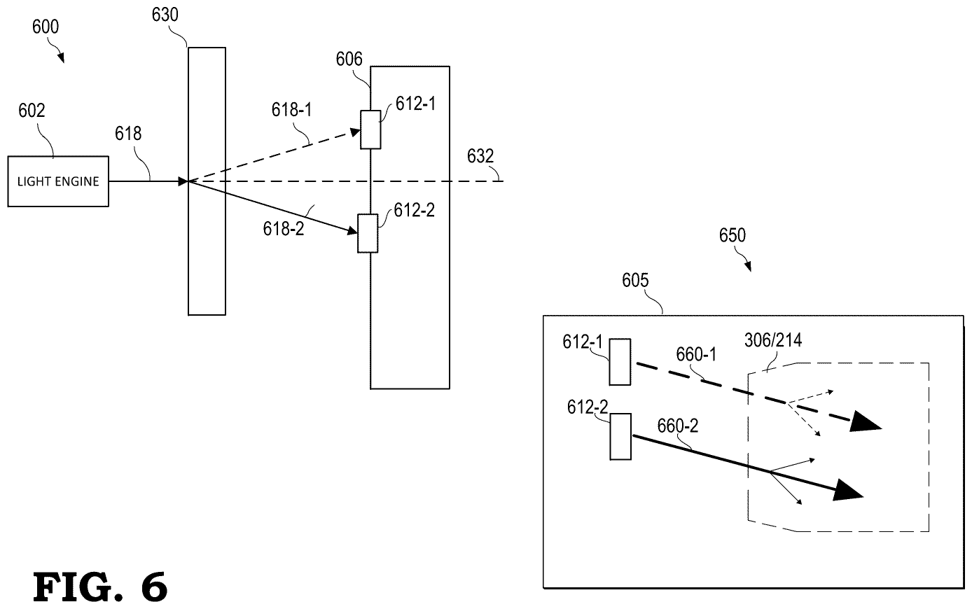

Accordingly, the diffractive element 530 splits light 518 into diffraction orders of light 518-1 to 518-3 and directs these diffraction orders of light to the incouplers 512-1 to 512-3 so that light is coupled into incouplers 512-1 to 512-3 at the appropriate angle(s) to encourage propagation of the light in waveguide 505 by TIR. In some embodiments, the diffractive element 530 is a Dammann grating. In some embodiments, the diffractive element 530 is a non-binary phase diffractive grating such as a sinusoidal grating. In some embodiments, diffractive element 530 is a symmetrical grating to produce symmetrical diffraction orders (as shown in FIG. 5). In other embodiments, the diffractive element 530 is a non-symmetrical grating in which the symmetry along the grating is broken by using blazed or slanted gratings. For example, in some embodiments, the diffractive element 530 includes a non-symmetrical grating for use with an even number (e.g., 2, 4, or 6) incouplers (shown in FIG. 6). In these cases, the diffractive element 530 diffracts the light into non-equal diffraction orders. To compensate for the non-equality of the diffraction orders, the incoupling efficiency of the corresponding incouplers is modulated by specifically designing the incoupler grating features to provide a common incoupling diffraction efficiency for the non-equal diffraction orders. Other examples of structures that can be used for the diffractive element 530 include Dammann blazed or slanted grating, a volume holographic grating, and a metasurface.

Waveguide diagram 550 corresponds to projection system diagram 500 and illustrates a world-side view of the waveguide showing the behavior of light after it is incoupled at each of the incouplers 512-1 to 512-3. That is, waveguide diagram 500 illustrates the behavior of the incoupled light as it propagates within the waveguide 505. Light path 560-1 corresponds to diffracted order of light 518-1 incoupled at incoupler 512-1, light path 560-2 corresponds to diffracted order of light 518-2 incoupled at incoupler 512-2, and light path 560-3 corresponds to diffracted order of light 518-3 incoupled at incoupler 512-3. In some embodiments, each of the incouplers 512-1 to 512-3 is designed such that it incouples its corresponding diffracted order of light 518-1 to 518-3 so that it propagates within the waveguide 505 with a common diffraction efficiency or common angle as the light incoupled at the other ones of the incouplers.

In some embodiments, the incouplers 512-1 to 512-3 are designed and tuned in accordance with the characteristics of the diffractive element 530 to avoid or reduce the generation of chromatic aberrations. In other words, the diffractive element 530 and of the incouplers 512-1 to 512-3 are designed in tandem with one another. For example, the incouplers 512-1 to 512-3 are designed such that the values corresponding to the expression k_{IC,N}+mk_{d} are constant, where k_{IC,N} is the k-vector of the Nth incoupler (IC) associated with the m=N diffraction order of the diffractive element 530, and k_{d} is the k-vector of the diffraction element. The k-vector of an element is defined as having a direction equal to the propagation direction of the plane wave and a magnitude equal to the refractive index of the medium at the wavelength of the wave. By designing the incouplers 512-1 to 512-3 such that the value of this expression is the same, the generation of chromatic aberrations is minimized or avoided altogether. Accordingly, the grating features (e.g., fill factor, pitch, grating height, grating angle, grating density, refractive index of the incoupler material) for each of the incouplers 512-1 to 512-3 are designed with respect to the diffractive features of the diffractive element 530, i.e., the incouplers 512-1 to 512-3 are designed based on the diffractive orders of light 518-1 to 518-3 generated by the diffractive element 530. In some embodiments, the grating features of the incouplers 512-1 to 512-3 are designed such that they generate a higher quality of eyebox uniformity. For example, since blue light decays quicker than other colors of light, the incoupler with optical paths farther away from the diffractive element 530 (incouplers 512-1 and 512-3) are designed to prioritize blue light incoupling efficiency such that the incoupling of blue light is similar to that of incoupler 512-2. Accordingly, by designing the incouplers 512-1 to 512-3 in tandem with the diffractive element 530, the spatial uniformity of light propagated within the waveguide and eventually to the eyebox of the eyewear display is improved.

Also shown in FIG. 5 is a cross-section diagram 540 of incoupler 512-3, that is rotated 90 degrees clockwise with respect to the configuration shown in projection system diagram 500. Cross-section diagram 540 illustrates some of the features of the incoupler grating that can be configured to tune the efficiency any one of incouplers 512-1 to 512-3. The period p of the grating is shown having two regions, with transmittances t1=1 and t2=0 and widths d1 and d2, respectively. As shown, the grating period is constant, p=d1+d2, but the relative widths d1, d2 of the two regions may vary. A fill factor parameter, x, can be defined such that d1=xp and d2=(1-x) p. Also, the grating period, p, is inversely related with the pitch of the grating. That is, reducing the grating period, p, will increase the grating pitch, and lengthening the grating period, p, will decrease the grating pitch. In addition, while the profile shape of the grating features in cross-section 540 is generally shown as being square or rectangular with a height, h, the shape can be modified based on the characteristics of light that the corresponding incoupler is intended to receive. For example, in some embodiments, the shape of the grating features is triangular, rather than square, to create a more “saw-toothed” profile. In some embodiments, the incouplers 512-1 to 512-3 are configured as a grating with a constant period but different fill factors, heights, and slant angles (shown as being orthogonal in diagram 540) based on the desired efficiency of the respective incoupler. In some embodiments, the diffractive element 530 includes similar grating features or corresponding grating features to those shown in diagram 540 that are also tuned based on the diffraction characteristics to be implemented by the diffractive element 530.

As shown in waveguide diagram 550, in some embodiments, each of the incouplers 512-1 to 512-3 couple light into the same EPE-OC system, such as a 2D EPE/OC system 305/214, via TIR within the waveguide 550. Accordingly, the spatial uniformity of light shown in diagram 550 is improved in comparison to the spatial uniformity of light shown in diagram 350. Although the 2D EPE/OC architecture is shown in FIG. 5, a similar diffractive element 530 and multiple incoupler 512-1 to 512-3 configuration may be implemented in other types of architecture such as a 1D EPE-OC architecture (such as that shown in diagram 300) or a 1D crossed EPE and OC design at different major surfaces of the waveguide (e.g., EPE and OC on different major surfaces 220, 222 of waveguide 205 in FIG. 2).

The architecture shown in FIG. 5 is symmetrical. That is, the diffractive element 530 splits the light into diffracted orders of light 518-1 to 518-3 that are symmetrical along the k-vector of incoupler 512-2, also referred to as the nominal or center incoupler in the shown configuration. In this manner, the design of incouplers 512-1 to 512-3 is simplified with symmetry about the k-vector of the nominal or center incoupler 512-2. In this configuration, the incouplers 512-1 and 512-3 impart the same diffraction angle of light incident upon them, i.e., incouplers 512-1 and 512-3 are mirrored about the k-vector of the nominal or center incoupler 512-2. Accordingly, in such a configuration, incouplers 512-1 and 512-3 share a similar grating pitch and relative orientation to the k-vector of the nominal or center incoupler 512-2. Accordingly, the design of incouplers 512-1 and 512-3 are symmetrical to one another to incouple the corresponding diffraction orders of light 518-1 and 518-3 at a common incoupling angle into the waveguide 505. As such, the light is propagated via TIR along light paths 560-1 to 560-3 that share a common direction to the same EPE and/or OC system, e.g., EPE/OC 305/214 in diagram 550.

While the embodiment shown in FIG. 5 illustrates a symmetrical diffractive element 530 and incoupler 512-1 to 512-3 configuration, in some embodiments, an asymmetrical configuration may be implemented. For example, a first type of asymmetrical configuration may be related to and defined by the angle between the k-vector of the diffractive element, such as diffractive element 530 in FIG. 5, and the k-vector of the nominal or center incoupler, such as the k-vector of incoupler 512-2 in FIG. 5. If this angle or its associated vector is not orthogonal, then a different grating feature such as a different grating pitch is needed in the other incouplers (e.g., such as the side incouplers 512-1 and 512-3 in FIG. 5). In some embodiments, the motivation for this first type of asymmetrical configuration is to reduce uniformities that occur in a particular direction. In another example, a second type of asymmetrical configuration is related to having unequal flux going to the side incouplers, e.g., such as incouplers 512-1 and 512-3 in FIG. 5. In this case, the diffractive element is implemented as a non-binary grating structure to break symmetry along the k-vector direction of the diffractive element. Examples of a non-binary grating structure include slanted or blazed gratings. In some embodiments, the motivation for this second type of asymmetrical configuration is that, in some cases, a better spatial uniformity is achieved if more light is directed to a particular incoupler compared to the other incouplers in the waveguide. In another embodiment, the diffraction efficiency of the nominal or center incoupler (e.g., such as incoupler 512-2 in FIG. 5) may be designed with a higher diffraction efficiency than the other incouplers. An asymmetrical configuration may also be implemented in systems with an even number of incouplers or when the incouplers are offset with respect to the diffractive element. Such a configuration is shown in FIG. 6

FIG. 6 illustrates a side view of a projection system diagram 600 and a corresponding waveguide diagram 650 in accordance with various embodiments. In some aspects, the components of projection system diagram 600 and corresponding waveguide diagram 650 correspond with those shown in FIG. 5 with differences in that in FIG. 6, two incouplers 612-1 and 612-2 are shown instead of the three incouplers shown in FIG. 5. Additionally, an asymmetric layout is shown in diagram 650 in that the light paths 660-1 and 660-2 are not orthogonal to their corresponding incouplers. And, although not shown in FIG. 6, the description of the grating features shown in diagram 540 in FIG. 5 are also applicable to the grating features of the diffractive element 630 and/or the incouplers 612-1 and 612-2.

In projection system diagram 600, the light engine 602 projects light 618 associated with displaying an image. The diffractive element 630 receives the light 618 and splits the light into two diffraction orders of light 618-1 and 618-2. Each of the two diffraction orders of light 618-1 and 618-2 are directed to one of two corresponding incouplers 612-1 and 612-2 on the waveguide 605. That is, the amount and location of the incouplers 612-1 and 612-2 are selected to coincide with the number of diffraction orders of light 618-1 and 618-2 generated by the diffractive element 630. In this example, this number is 2, but it is appreciated that this number may be scalable to other amounts, e.g., 3, 4, 5, or 6.

As shown in projection system diagram 600, the diffractive element 630 is placed between the light engine 602 and the waveguide 605 to allow for the incouplers 612-1 and 612-2 to be spatially separated in order to receive its corresponding diffraction order of light 618-1 and 618-2. Accordingly, the configuration shown in diagram 600 includes considerations for the placement and location of the diffractive element 630 in the optical path between the light engine 602 and the waveguide 605. In some embodiments, the diffractive element 630 is designed with diffractive features to generate the diffractive orders of light 618-1 and 618-2 based on the physical distance and/or optical path length of light between the waveguide 605 and the light engine 602. For example, in order to achieve the output of the diffraction orders of light 618-1 and 618-2, the diffractive element 630 includes grating features that are blazed and/or slanted. Moreover, in the configuration shown in FIG. 6, the diffractive element 630 (e.g., a Dammann grating) is designed to suppress the 0th order diffraction order, i.e., the order of light coinciding with the diffractive element's k-vector 632, so that only a positive diffractive order of light (e.g., +1 order corresponding to 618-1) and a negative diffractive order of light (e.g., −1 order corresponding to 618-2). In this manner, the diffractive element 630 may be implemented with an even number of incouplers. In some embodiments, the diffractive element is designed with grating features to generate additional orders of light in addition to the two orders of light shown in FIG. 6.

Waveguide diagram 650 corresponds to projection system diagram 600 and illustrates the behavior of light after it is incoupled at each of the incouplers 612-1 and 612-2. That is, waveguide diagram 600 illustrates the incoupling of each of the diffracted orders of light 618-1 and 618-2 at each one of the incouplers 612-1 and 612-2. Light path 660-1 corresponds to diffracted order of light 618-1 incoupled at incoupler 612-1, and light path 650-2 corresponds to diffracted order of light 618-2 incoupled at 612-2. In some embodiments, each of the incouplers 612-1 and 612-2 is designed such that it incouples its corresponding diffracted order of light 618-1 and 618-2 so that it propagates within the waveguide 605 with a common diffraction efficiency and/or common angle as the light incoupled at the other ones of the incouplers. Since the configuration shown in FIG. 6 is asymmetrical, this means that the grating features of incouplers 612-1 and 612-2 are not equal. For example, the grating pitches and/or the grating angles of incouplers 612-1 and 612-2 are designed such that the input field angles from the light engine are mapped to the same guided vector directions after diffraction by each incoupler. The grating design constraints of the incouplers 612-1 and 612-2 may be mathematically modeled according to the following equation:

$${k}_{IC 1} + {k}_{d} = {k}_{IC 2} - {k}_{d}$$

where k_{IC1} is the k-vector associated with incoupler 612-1 to a common guided k-point after diffraction by the incoupler in the waveguide 605 (to achieve TIR), k_{IC2} is the k-vector associated with incoupler 612-2 to the common guided k-point after diffraction by the incoupler in the waveguide 605 (to achieve TIR), and k_{d} represents the k-vector of the diffractive element 630. By designing the grating features of the incouplers 612-1 and 612-2 in accordance with this mathematical model, the generation of chromatic aberrations is avoided while achieving a uniform spatial density of the light in and produced by the system shown in FIG. 6.

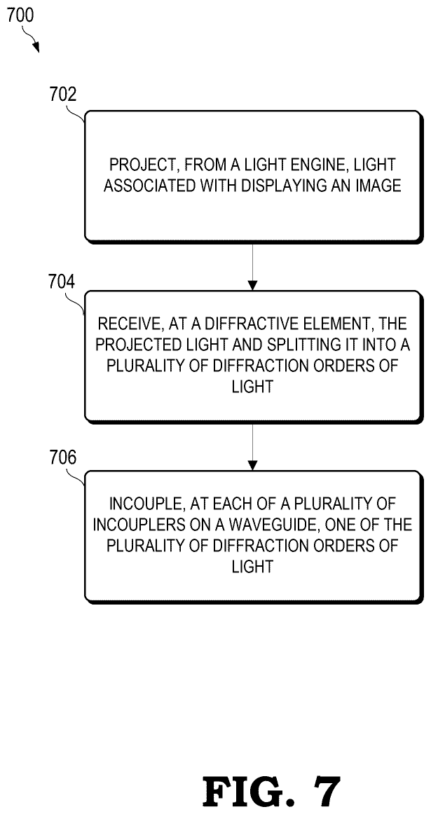

FIG. 7 shows a method flowchart 700 in accordance with various embodiments. The method shown by flowchart 700 improves the spatial uniformity of the light in and delivered by a projection system, such a projection system in the preceding figures, in an eyewear display, such as that shown in FIG. 1.

At 702, the method includes projecting, from a light engine, light associated with displaying an image. In some embodiments, the light engine corresponds to light engine 202 shown in FIGS. 2 and 4 and light engines 502 and 602 shown in FIGS. 5 and 6, respectively. At 704, the method includes receiving, at a diffractive element, the projected light and splitting the light into a plurality of diffraction orders of light. In some embodiments, the diffractive element corresponds to the diffractive element shown in any of FIGS. 2 and 4 (diffractive element 230), FIG. 5 (diffractive element 530), or FIG. 6 (diffractive element 630). At 706, the method includes incoupling, at each of a plurality of incouplers on a waveguide, one of the plurality of diffraction orders of light. In some embodiments, the incouplers correspond to the incouplers shown in any of FIGS. 2 and 4 (incouplers 212), FIG. 5 (incouplers 512-1 to 512-3), and FIG. 6 (incouplers 612-1 to 612-2).

In some embodiments, the techniques described herein can be implemented in an eyewear display with multiple waveguides. For example, each waveguide in such a multiple waveguide system may be configured to propagate light of a particular color or may be configured for different FOVs or different focal planes in an eyewear display system. For example, the techniques described herein may be implemented for only one waveguide in a multiple waveguide system if better spatial uniformity for the light associated with this waveguide is to be prioritized. In other embodiments, the diffractive element can be placed in between waveguides in a multiple waveguide system.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An eyewear display comprising:
a light engine to project light associated with displaying an image;
a waveguide comprising a plurality of incouplers; and
a diffractive element between the light engine and the waveguide to receive the light projected by the light engine, split the light into a plurality of diffraction orders of light, and direct one diffraction order of light of the plurality of diffraction orders of light to one incoupler of the plurality of incouplers.

2. The eyewear display of claim 1, wherein the diffractive element is a diffractive grating.

3. The eyewear display of claim 2, wherein the diffractive grating is a binary phase diffractive grating to generate the plurality of diffraction orders of light with an equal intensity.

4. The eyewear display of claim 1, wherein the diffractive element is configured to split the light into the plurality of diffraction orders of light so that each diffraction order of light of the plurality of diffraction orders of light replicates an input pupil at one incoupler of the plurality of incouplers.

5. The eyewear display of claim 1, wherein each diffraction order of light of the plurality of diffraction orders of light exits the diffractive element at a different angle with respect to other ones of the plurality of diffraction orders of light.

6. The eyewear display of claim 5, wherein each of the plurality of incouplers includes grating features to incouple a corresponding diffraction order of light of the plurality of diffraction orders of light.

7. The eyewear display of claim 6, wherein the grating features comprise one or more of a grating height, pitch, fill factor, grating angle, or refractive index of grating material.

8. The eyewear display of claim 7, wherein each incoupler of the plurality of incouplers incouples the corresponding diffraction order of light into the waveguide along a common incoupling angle.

9. The eyewear display of claim 7, wherein each incoupler of the plurality of incouplers incouples the corresponding diffraction order of light into the waveguide at a common diffraction efficiency with respect to diffraction orders of light incoupled at other ones of the plurality of incouplers.

10. The eyewear display of claim 1, further comprising a hinge, wherein the diffractive element is located in the hinge.

11. The eyewear display of claim 1, further comprising a hinge, wherein the diffractive element is between the hinge and the light engine, and wherein the light engine is located in an arm of the eyewear display.

12. The eyewear display of claim 1, wherein the plurality of incouplers is on a same major surface of the waveguide.

13. The eyewear display of claim 1, wherein each of the plurality of incouplers are configured to redirect the light toward a two-dimensional (2D) exit pupil expander-outcoupler (EPE/OC) along a separate optical path.

14. The eyewear display of claim 1, wherein the plurality of incouplers is arranged symmetrically on the waveguide with respect to the diffractive element.

15. The eyewear display of claim 1, wherein the plurality of incouplers is arranged asymmetrically on the waveguide with respect to the diffractive element.

16. A method to direct light in an eyewear display, the method comprising:
projecting, from a light engine, light associated with displaying an image;
receiving, at a diffractive element, the light and splitting it into a plurality of diffraction orders of light; and
incoupling, at each of a plurality of incouplers on a waveguide, a corresponding diffraction order of light of the plurality of diffraction orders of light such that it is propagated along with waveguide by total internal reflection (TIR).

17. The method of claim 16, wherein splitting the light into the plurality of diffraction orders of light results in each diffraction order of the plurality of diffraction orders of light replicating an input pupil at a corresponding incoupler of the plurality of incouplers.

18. The method of claim 16, wherein each of the plurality of diffraction orders of light of light exit the diffractive element at a different angle with respect to one another.

19. The method of claim 18, wherein each of the plurality of incouplers incouple a corresponding diffraction order of light into the waveguide along a common incoupling angle or at a common diffraction efficiency with respect to diffraction orders of light incoupled at other ones of the plurality of incouplers.

20. The method of claim 18, wherein each of the plurality of incouplers include grating features tuned to account for the different angles of the plurality of diffraction orders of light received from the diffractive element.

21. The method of claim 16, further comprising:
receiving, from the plurality of incouplers at an outcoupler, the plurality of diffraction orders of light along different light paths; and
outcoupling, at the outcoupler, the plurality of diffraction orders of light out of the waveguide and to an eyebox of the eyewear display.

22. (canceled)

23. (canceled)
